(19) United States
(12) Patent Application Publication
(10) Pub. No.: US 2026/0019152 A1
(43) Pub. Date: Jan. 15, 2026

(54) OPTICAL MONITOR DEVICE AND OPTICAL INTENSITY MEASUREMENT METHOD

(71) Applicant: NIPPON TELEGRAPH AND TELEPHONE CORPORATION, Tokyo (JP)

(72) Inventors: Ryo KOYAMA, Musashino-shi, Tokyo (JP); Yoshiteru ABE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/994,968

(22) PCT Filed: Jul. 28, 2022
(86) PCT No.: PCT/JP2022/029109

§ 371 Date: Jan. 15, 2025

(51) Int. Cl. H04B 10/079; G01J 1/44; H04B 10/25

(52) U.S. Cl. CPC H04B 10/07955; G01J 1/44; H04B 10/25

(57) ABSTRACT

An object of the present disclosure is to enable measurement of a light intensity beyond a limit of a measurable intensity of light receiving elements using a light receiving portion in which many light receiving elements are two-dimensionally arranged.

The present disclosure is an optical monitor device that detects an intensity of light propagating through a plurality of optical fibers, the optical monitor device including: an optical component that splits a part of incident light from the plurality of optical fibers into a first direction and a rest into a second direction at a constant splitting ratio, and emits light; and a light receiving portion that receives emitted light in a second direction from the optical component, in which the light receiving portion includes a light receiving surface having a size that enables light reception of all emitted light from the optical component in the second direction, light receiving elements larger in number than the optical fibers are two-dimensionally arranged on the light receiving surface, and exposure times of the light receiving elements are variable.

### TECHNICAL FIELD

The present disclosure relates to an optical monitor device, and particularly relates to an optical monitor device for detecting an intensity of light and feeding back a detection result to other components in an optical transmission device or the like.

### BACKGROUND ART

With an increase in Internet traffic, it is strongly required to increase a communication capacity in a communication system in recent years. In order to implement this, a communication system using optical fibers is used in an access network between a communication station building and a user's home or a core network connecting communication station buildings. In optical fiber communication, detection of a light intensity propagating through an optical fiber is often used for controlling communication and checking soundness of equipment. For example, in an access network, test light is propagated through optical fibers, and a loss and soundness of the optical fibers, a core target, connection, and the like are checked from detection of the light intensity. Furthermore, in wavelength division multiplexing (WDM) transmission used in a core network, it is necessary to monitor a light intensity for feedback control.

In light intensity monitoring of an access network, for example, a technology described in Patent Literature 1 is used. Patent Literature 1 describes a technology of splitting light at a constant splitting ratio by two parallel waveguides, and the technology enables measurement of an intensity and a propagation loss of an optical signal in an access network.

For light intensity monitoring in WMD transmission, for example, the technology of Patent Literature 2 is used.

Patent Literature 2 describes a technology for simultaneously monitoring the intensities of optical signals of a plurality of optical fibers by a combination of one-dimensionally arranged optical fibers and a dielectric multilayer film.

However, an optical monitor device having the conventional arrangement configuration still has the following issues.

While optical communication has become widespread and the number of optical fibers of an optical facility/optical cable has increased, first, the cost and size increase with the increase in the number of optical fibers in the case of an optical monitor device using an optical coupler for each optical fiber. Also in the case of an optical monitor device in which optical fibers and light intensity sensors are arranged in a one-dimensional array, there is a limit to the array arrangement of the optical fibers, and if the number of optical fibers is increased beyond the limit, the cost and size increase according to the number.

Furthermore, since the optical fibers and the light intensity sensors correspond to each other on a one-to-one basis, it is necessary to arrange the sensors and the optical fibers at the same pitch. Further, accurate positioning needs to be performed so that light of the optical fibers is made incident on the sensors.

As a technology for solving this issue, a method of using a light receiving portion in which light receiving elements larger in number than optical fibers are two-dimensionally arranged is conceivable. The light receiving portion in which many light receiving elements are two-dimensionally arranged generally has a fine structure manufactured using a semiconductor process, but an electrical element such as an optical sensor, a circuit resistor, or a capacitor included in such a fine light receiving element as a single body is generally greatly inferior in a characteristic such as an electromotive force, a resistance value, and sensitivity to a light receiving element used in Patent Literature 1 and 2, and a ratio Smax/Smin of a measurable maximum intensity Smax and a minimum intensity Smin of the light receiving element falls generally far below that of the light receiving element used in Patent Literature 1 and 2. Therefore, there is an issue that a range of measurable light intensities has a limit.

### CITATION LIST

### Patent Literature

Patent Literature 1: JP 3450104 B2
Patent Literature 2: JP 2004-219523 A

### SUMMARY OF INVENTION

### Technical Problem

The present disclosure has been made in view of such a point, and an object of the present disclosure is to enable measurement of a light intensity beyond a limit of measurable intensities of light receiving elements using a light receiving portion in which many light receiving elements are two-dimensionally arranged.

### Solution to Problem

An optical monitor device according to the present disclosure is
an optical monitor device that detects an intensity of light propagating through a plurality of optical fibers, the optical monitor device including:
an optical component that splits a part of incident light from the plurality of optical fibers into a first direction and a rest into a second direction at a constant splitting ratio, and emits light; and
a light receiving portion that receives emitted light in a second direction from the optical component,
in which the light receiving portion includes a light receiving surface having a size that enables light reception of all emitted light from the optical component in the second direction,
light receiving elements larger in number than the optical fibers are two-dimensionally arranged on the light receiving surface, and
exposure times of the light receiving elements are variable.

There may be included an exposure time setting unit that changes the exposure times such that a ratio Smax/Smin of a measurable maximum intensity Smax and a minimum intensity Smin of the light receiving elements is made smaller than a ratio Pmax/Pmin of a maximum intensity Pmax and a minimum intensity Pmin of light to be measured. Furthermore, exposure times may be variable for each of the light receiving elements in the light receiving portion.

The optical component may include: a single-layer film that is having a uniform thickness and splits a part of the incident light in the first direction and a rest in the second direction at a constant splitting ratio; an incident-side member included on an incident side of the single-layer film and having a refractive index different from a refractive index of the single-layer film; and an emission-side member included on an emission side of the single-layer film and having a same refractive index as a refractive index of the incident-side member. In this case, each of a first refractive index interface between the single-layer film and the incident-side member and a second refractive index interface between the single-layer film and the emission-side member may be included at a specific angle with respect to an optical axis of incident light, the first direction may be a direction in which transmission occurs through the first refractive index interface and the second refractive index interface, and the second direction may be a direction in which reflection occurs on the first refractive index interface and the second refractive index interface.

An optical monitor device according to the present disclosure may include:
a plurality of incident-side optical fibers 11 that is two-dimensionally arranged so as to make light incident on the optical component;
a plurality of emission-side optical fibers that is two-dimensionally arranged to receive each piece of emitted light from the optical component in the first direction;
an incident-side optical lens that is arranged between the optical component and the incident-side optical fibers and collimates each piece of incident light to the optical component; and
an emission-side optical lens that is arranged between the optical component and the emission-side optical fibers and couples each piece of emitted light from the optical component to the emission-side optical fibers.

A light intensity measurement method according to the present disclosure is
a light intensity measurement method for collectively measuring intensities of light propagating through a plurality of optical fibers using the optical monitor device of the present disclosure, the light intensity measurement method including:
acquiring in advance correspondence relationships between the plurality of optical fibers and each light receiving element by measuring a received light intensity at each light receiving element when light is emitted by each optical fiber from the plurality of optical fibers; and
measuring a light intensity of each light receiving element received by the light receiving portion in a state where the plurality of optical fibers is propagating light to be measured for an intensity,
in which the measurement is performed a plurality of times while an exposure time during which emitted light in the second direction is incident on each light receiving element is changed.

In the measurement, an exposure time of a light receiving element may be extended in a case where a light intensity received by any of the light receiving elements arranged in a range determined by the correspondence relationships is smaller than the minimum intensity Smin of the light receiving elements. In this case, an exposure time of a light receiving element smaller than the minimum intensity Smin may be extended until the minimum intensity Smin is exceeded in all the light receiving elements arranged in a range determined by the correspondence relationships or a number of times of extension β reaches a predetermined number of times set in advance. The extended exposure time may be determined by KPT by using a number of times of extension β.

In the measurement, an exposure time of a light receiving element may be shortened in a case where a light intensity received by any of the light receiving elements arranged in a range determined by the correspondence relationships is larger than the maximum intensity Smax of the light receiving elements. In this case, an exposure time of a light receiving element larger than the maximum intensity Smax may be shortened until the intensity falls below the maximum intensity Smax in all the light receiving elements arranged in a range determined by the correspondence relationships. The exposure time may be determined by T/K^{γ} by using the number of times of the shortening γ.

An optical monitor device of the present disclosure may include:
a plurality of incident-side optical fibers that is two-dimensionally arranged so as to make light incident on the optical splitting unit;
a plurality of emission-side optical fibers that is two-dimensionally arranged to receive each piece of emitted light from the optical splitting unit in the first direction;
an incident-side optical lens that is arranged between the optical splitting unit and the incident-side optical fibers and collimates each piece of incident light to the optical splitting unit; and
an emission-side optical lens that is arranged between the optical splitting unit and the emission-side optical fibers and couples each piece of emitted light from the optical splitting unit to the emission-side optical fibers.

Note that the disclosures described above can be combined in any possible manner.

### Advantageous Effects of Invention

According to the present disclosure, in a case where light is received using a light receiving portion in which light receiving elements larger in number than optical fibers are two-dimensionally arranged on a light receiving surface, it is possible to measure a light intensity that exceeds a limit of measurable intensities of the light receiving elements.

### BRIEF DESCRIPTION OF DRAWINGS

FIG. 1 illustrates an exemplary embodiment of an optical monitor device of the present disclosure.

FIG. 2 illustrates an arrangement example of incident-side optical fibers.

FIG. 3 illustrates an arrangement example of light receiving elements in a light receiving portion.

FIG. 4 illustrates an example of a light intensity measurement method of the present disclosure.

FIG. 5 illustrates an example of light propagating through a spatial optical system.

FIG. 6 illustrates an exemplary embodiment of an optical monitor device of the present disclosure.

### DESCRIPTION OF EMBODIMENTS

Hereinafter, embodiments of the present disclosure will be described in detail with reference to the drawings.

Note that the present disclosure is not limited to the embodiments described below. These embodiments are merely examples, and the present disclosure can be implemented in a form with various modifications and improvements on the basis of the knowledge of those skilled in the art. Note that components having the same reference signs in the present specification and the drawings indicate the same components.

### First Exemplary Embodiment

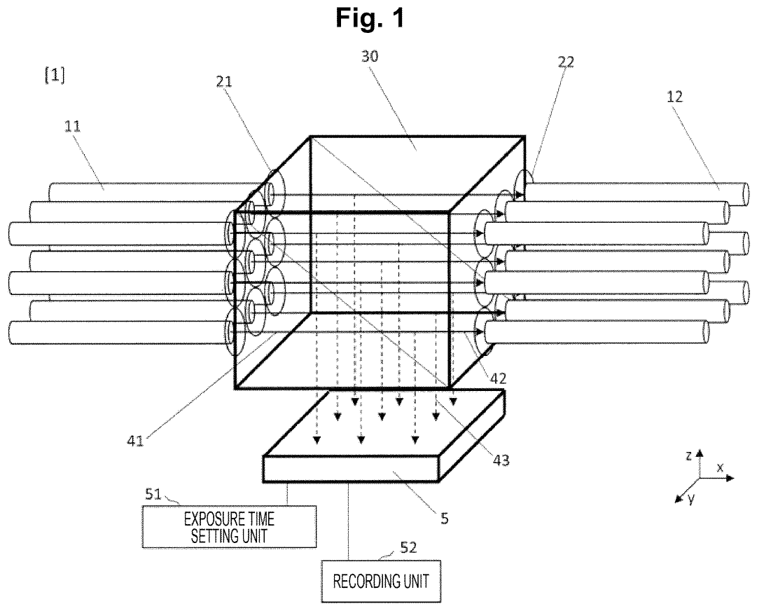

An optical monitor device of the present embodiment has a configuration illustrated in FIG. 1.

The optical monitor device of the present embodiment is an optical monitor device that detects an intensity of light propagating through a plurality of incident-side optical fibers 11, the optical monitor device including: a spatial optical system 30 that splits most incident light into a specific first direction and the rest into a different specific second direction at a constant splitting ratio for each piece of incident light 41 from the incident-side optical fibers 11, and emits each piece of split light;
the plurality of incident-side optical fibers 11 that is two-dimensionally arranged so as to make light incident on the spatial optical system 30;
a plurality of emission-side optical fibers 12 that is arranged to receive emitted light 42 emitted from the spatial optical system 30 in the first direction;
a light receiving portion 5 that is arranged to receive the emitted light 43 emitted from the spatial optical system 30 in the second direction;
an incident-side optical lens 21 that is arranged between the spatial optical system 30 and the incident-side optical fibers 11 and collimates each piece of incident light from the incident-side optical fibers 11 to the spatial optical system 30; and
an emission-side optical lens 22 that is arranged between the spatial optical system 30 and the emission-side optical fibers 12 and efficiently couples each piece of emitted light from the spatial optical system 30 to the emission-side optical fibers 12 corresponding to the incident side optical fibers 11.

According to the present disclosure, when the light receiving portion 5 receives emitted light in the second direction, at least one of
(i) a light intensity received by the light receiving portion 5,
(ii) a light intensity of incident light that is made incident from the plurality of incident-side optical fibers 11, or
(iii) a light intensity of emitted light emitted to the plurality of emission-side optical fibers 12 can be measured.

FIG. 1 illustrates an example in which the first direction is the x-axis direction and the second direction is the z-axis direction, but the direction of reflected light to be split into the second direction is not fixed to 90 degrees and can be changed as necessary. Furthermore, the spatial optical system 30 is not limited to a spatial system, and any optical component including a splitting surface capable of splitting light into two pieces of light having different directions can be used.

According to the optical monitor device illustrated in FIG. 1, light from the incident-side optical fibers 11 becomes parallel light in the incident-side optical lens 21, and is prevented from being lost due to diffusion. Further, most emitted light 42 is guided to the emission-side optical lens 22 by the spatial optical system 30. The emission-side optical lens 22 collects light passing through the spatial optical system 30 and is coupled to the emission-side optical fibers 12. In this manner, most emitted light 42 emitted from the incident-side optical fibers 11 can be guided to the emission-side optical fibers 12 with a small loss.

On the other hand, a part of emitted light 43 split by the spatial optical system 30 is guided to the light receiving portion 5 arranged in a direction different from the most emitted light 42. The light receiving portion 5 includes a light receiving surface having a size that enables reception of all the emitted light 43 from the spatial optical system 30. On the light receiving surface of the light receiving portion 5, light receiving elements larger in number than the incident-side optical fibers 11 are two-dimensionally arranged. As a result, it is possible to measure the intensity of a part of light propagating from the incident-side optical fibers 11 to the emission-side optical fibers 12.

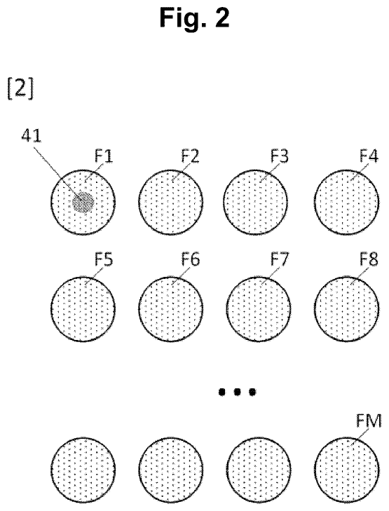

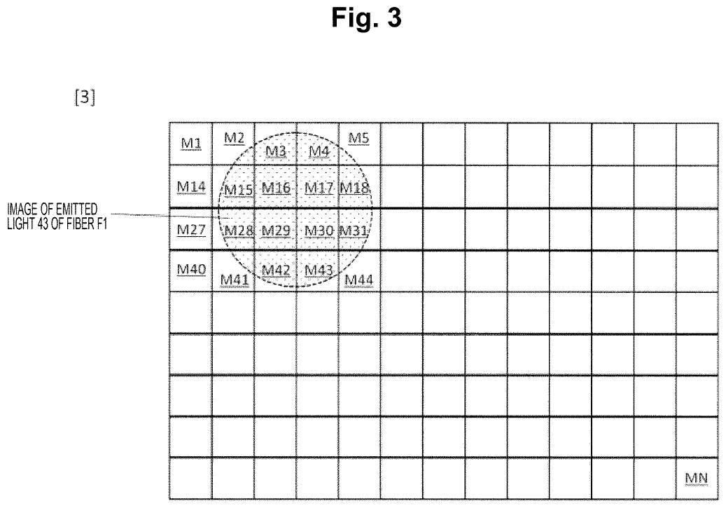

FIG. 2 illustrates arrangement of the incident-side optical fibers 11, and FIG. 3 illustrates arrangement of the light receiving elements on the light receiving surface of the light receiving portion 5. M incident-side optical fibers F1 to FM are two-dimensionally arranged at a constant pitch by four. N light receiving elements M1 to MN are two-dimensionally arranged at a constant pitch. In the present disclosure, the pitch of the incident-side optical fibers F1 to FM and the pitch of the light receiving elements M1 to MN are not matched, and no special alignment is performed, and thus in a case where incident light 41 is made incident from an incident-side optical fiber F1, an image of emitted light 43 of the incident-side optical fiber F1 can be formed on the light receiving surface of the light receiving portion 5 as illustrated in FIG. 3, for example. At this time, the emitted light 43 is detected by light receiving elements M2 to M5, M15 to M18, M28 to M31, and M41 to M44. The light receiving portion 5 detects the sum of light intensities detected by the light receiving elements M2 to M5, M15 to M18, M28 to M31, and M41 to M44 as the light intensity of the emitted light 43 of the incident-side optical fiber F1.

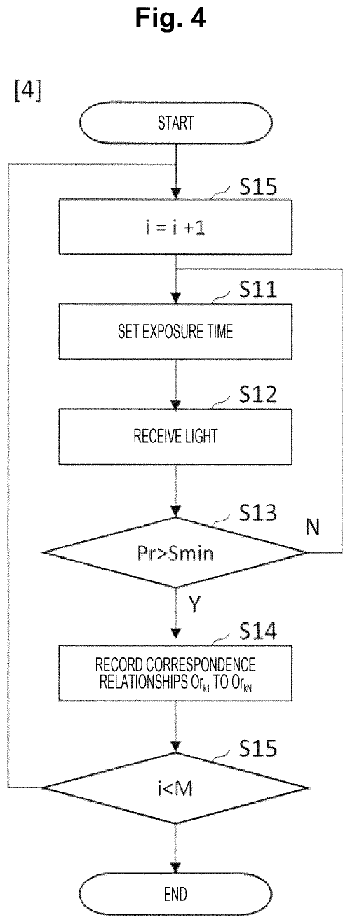

Therefore, in the present disclosure, as illustrated in FIG. 4, regarding the light intensities of the respective light receiving elements M1 to MN at the time when light having reference intensity Pr is emitted from the incident-side optical fiber F1, the time during which the emitted light 43 is made incident on the light receiving portion 5 (hereinafter, exposure time) is set to a constant time T (S11), light is received by the light receiving portion 5 (S12), and measurement results obtained by light reception are recorded (S14). As a result, correspondence relationships Or₁₁ to Or_{1N} between the incident-side optical fiber F1 and the light receiving elements M1 to MN can be acquired. Similarly, correspondence relationships Or₂₁ to Or_{MN} between incident-side optical fibers F2 to FM and the light receiving elements M1 to MN are recorded for incident-side optical fibers F2 to FM (S15).

Here, the light receiving portion 5 of the present disclosure includes an exposure time setting unit 51 that sets exposure times of the respective light receiving elements, and a recording unit 52 that records received light intensities of the respective light receiving elements. As described above, in the present disclosure, the exposure times of the respective light receiving elements of the light receiving portion 5 are variable. For example, the exposure time setting unit 51 shortens exposure times of the light receiving elements M1 to MN illustrated in FIG. 3 from T or extends the exposure times from T. The recording unit 52 records received light intensities of the respective light receiving elements in consideration of the exposure times.

As a method of changing an exposure time, for example, in a case where the light receiving portion 5 includes a capacitor that accumulates electric charge flowing through the light receiving elements, such as a charge coupled device (CCD) sensor or a complementary metal oxide semiconductor (CMOS) sensor, a method of controlling the charging time of the capacitor using switching elements included between the light receiving elements and the capacitor can be exemplified. Furthermore, a method of performing control using shutters installed in front of light receiving surfaces of light receiving elements of a CCD sensor, a CMOS sensor, or the like can be used.

In recording of the correspondence relationships Or₁₁ to Or_{MN}, if only light having a light intensity that falls below the measurable minimum intensity Smin of the light receiving elements M1 to MN is made incident (No in S13), Or₁₁ to Or_{MN} cannot be correctly recorded. For example, this is a case where light that exceeds the minimum intensity Smin is detected only in light receiving elements M16, M17, M29, and M30 illustrated in FIG. 3, and the other light receiving elements do not reach the minimum intensity Smin.

The approximate area of the emitted light 43 on the light receiving surface of the light receiving portion 5 can be calculated by the numerical apertures of the incident-side optical fibers 11 or the like. Therefore, the exposure time setting unit 51 extends exposure times until light receiving elements M2 to M5, M15 to M18, M28 to M31, and M41 to M44 arranged in a range determined by the area around the light receiving elements M16, M17, M29, and M30 exceed the minimum intensity Smin.

At this time, in step S11, the exposure times are extended to KT using any value K larger than 1 and smaller than a ratio Smax/Smin of the maximum intensity Smax and the minimum intensity Smin. Then, steps S12 to S14 are performed, and recording is performed again.

If there is still a record that falls below Smin in step S13, the exposure times are further extended to K²T in step S11, and recording is performed again (S12 to S14).

In this way, multiplying the exposure times by K and performing recording again are repeated similarly until records of all light receiving elements arranged in the range determined by the approximate area of the emitted light 43 exceed Smin. For example, in a case of the R-th time of extension, the exposure times are set to KPT. In consideration of the exposure times, the recording unit 52 multiplies recording values by 1/K, 1/K², 1/K³ . . . that are the reciprocals of the multiples of the exposure time when the exposure times are set to KT, K²T, K³T . . . , and records them as Or₁₁ to Or_{MN}.

Note that, in the present embodiment, the exposure times are extended until the recordings of all light receiving elements of all the light receiving elements M2 to M5, M15 to M18, M28 to M31, and M41 to M44 that light reaches exceed Smin, but the present disclosure is not limited thereto. For example, the exposure times may be extended until the number of times of extension β reaches a predetermined number of times set in advance.

Furthermore, since the number of light receiving elements to be used in the present disclosure only needs to be sufficient to solve Formula 3 to be described below, the number of elements to be used can be reduced within a range in which accuracy is not affected. For example, the number of elements to be used for measurement may be determined in advance and the extension of the exposure times may be repeated until elements to be used corresponding to the number exceed the minimum intensity Smin. In the example of FIG. 3, the number of elements may be determined to be four, and the processing may proceed to step S14 when the minimum intensity Smin is larger in the light receiving elements M16, M17, M29, and M30 in step S13.

Furthermore, by the value of K being set to a value larger than 1 and smaller than the ratio Smax/Smin of the maximum intensity Smax and the minimum intensity Smin, ranges of measurable light intensities can be made to overlap with each other as a result of measurement in a plurality of exposure times. For example, in a case where Smin=15 and Smax=60 are defined at the time of a recording time T, Smax/Smin=4 is obtained, and thus if K=3 is set, light having a light intensity of S=15 to 60 can be measured using an exposure time T, and light having a light intensity of S=5 to 20 can be measured using an exposure time KT. Accordingly, light having a light intensity of S=3 to 60 can be measured by combining these two measurements. However, in a case where K=5 is set, light having a light intensity of S=15 to 60 can be measured using the exposure time T, and light having a light intensity of S=1 to 12 can be measured using the exposure time KT, but light having a light intensity of S=12 to 15 cannot be correctly measured.

In the recording of the correspondence relationships Or₁₁ to Or_{MN}, in a case where light having a light intensity that exceeds the maximum intensity Smax is made incident conversely, the exposure times are similarly shortened to T/K, T/K², T/K³ . . . , and recording is repeated until all records fall below Smax. As described above, when the number of times of shortening is set to γ, the exposure times are set to T/K^{γ} in a case of the γ-th time of shortening. In consideration of the exposure times, the recording unit 52 multiplies recording values by K, K², K³ . . . that are the reciprocals of the multiples of the exposure times when the exposure times are set to T/K, T/K², T/K³ . . . , and records them as Or₁₁ to Or_{MN}.

The correspondence relationships between the incident-side optical fibers F1 to FM and the light receiving elements M1 to MN can be expressed as follows.

$$\begin{matrix}[ Math . 1 ] & \\ ( \begin{matrix}{Or}_{11} & … & {Or}_{M 1} \\ ⋮ & ⋱ & ⋮ \\ {Or}_{1 N} & … & {Or}_{MN}\end{matrix} ) & ( Formula 1 )\end{matrix}$$

Here, Orᵢⱼ is a light intensity received by the j-th light receiving element included in the light receiving portion 5 when light is emitted from the i-th optical fiber among the incident-side optical fibers F1 to FM.

Next, light intensities O₁ to O_{N} detected by the respective light receiving elements M1 to MN when pieces of light k₁ to k_{M} times more intense than the reference intensity Pr are made incident from the respective incident-side optical fibers F1 to FM are recorded.

Also in the recording of O₁ to O_{N}, in a case where only light having a light intensity that falls below the minimum intensity Smin is made incident, and conversely, in a case where light having a light intensity that exceeds the maximum intensity Smax is made incident, O₁ to O_{N} are recorded by the method illustrated in FIG. 4.

The recorded light intensities O₁ to O_{N} are the sums of the light made incident from the respective optical fibers F1 to FM, and are expressed by Formula 2.

$$\begin{matrix}[ Math . 2 ] & \\ ( \begin{matrix}{O}_{1} \\ ⋮ \\ {O}_{N}\end{matrix} ) = ( \begin{matrix}{Or}_{11} & … & {Or}_{M 1} \\ ⋮ & ⋱ & ⋮ \\ {Or}_{1 N} & … & {Or}_{MN}\end{matrix} ) ( \begin{matrix}{k}_{1} \\ ⋮ \\ {k}_{M}\end{matrix} ) & ( Formula 2 )\end{matrix}$$

Therefore, the light intensities that are made incident on the light receiving portion 5 from the respective optical fibers F1 to FM are expressed by Formula 3.

$$\begin{matrix}[ Math . 3 ] & \\ Pr ( \begin{matrix}{k}_{1} \\ ⋮ \\ {k}_{M}\end{matrix} ) = {Pr ( \begin{matrix}{Or}_{11} & … & {Or}_{M 1} \\ ⋮ & ⋱ & ⋮ \\ {Or}_{1 N} & … & {Or}_{MN}\end{matrix} )}^{- 1} ( \begin{matrix}{O}_{1} \\ ⋮ \\ {O}_{N}\end{matrix} ) & ( Formula 3 )\end{matrix}$$

Since the splitting ratio of the spatial optical system 30 is constant, for example, when the splitting ratio is α:1, it can be estimated that the light intensities that are made incident from the incident-side optical fibers 11 are Formula 4 and the light intensities propagated to the emission-side optical fibers 12 are Formula 5.

$$\begin{matrix}[ Math . 4 ] & \\ Pr ( α + 1 ) ( \begin{matrix}{k}_{1} \\ ⋮ \\ {k}_{M}\end{matrix} ) = Pr ( α + 1 ) {( \begin{matrix}{Or}_{11} & … & {Or}_{M 1} \\ ⋮ & ⋱ & ⋮ \\ {Or}_{1 N} & … & {Or}_{MN}\end{matrix} )}^{- 1} ( \begin{matrix}{O}_{1} \\ ⋮ \\ {O}_{N}\end{matrix} ) & ( Formula 4 )\end{matrix}$$

$$\begin{matrix}[ Math . 5 ] & \\ Pr α ( \begin{matrix}{k}_{1} \\ ⋮ \\ {k}_{M}\end{matrix} ) = Pr {α ( \begin{matrix}{Or}_{11} & … & {Or}_{M 1} \\ ⋮ & ⋱ & ⋮ \\ {Or}_{1 N} & … & {Or}_{MN}\end{matrix} )}^{- 1} ( \begin{matrix}{O}_{1} \\ ⋮ \\ {O}_{N}\end{matrix} ) & ( Formula 5 )\end{matrix}$$

A light intensity measurement method of the present disclosure includes:
acquiring in advance correspondence relationships expressed by Formula 1;
measuring light intensities by the light receiving portion 5 using Formula 3 in a state where the incident-side optical fibers 11 are propagating light to be measured for the intensity;
measuring the light intensities of the incident light 41 from the incident-side optical fibers 11 using Formula 4; and
measuring the light intensities of the emitted light 42 propagated to the emission-side optical fibers 12 using Formula 5.

The light intensities in the light receiving portion 5 are measured by detecting the received light intensities in the respective light receiving elements at the time of emission of each of the incident-side optical fibers 11. In the present embodiment, the correspondence relationships between the incident-side optical fibers 11 and each of the light receiving elements are acquired in advance. Therefore, it is possible to collectively measure the intensities of light propagating through the incident-side optical fibers 11 on the basis of the correspondence relationships.

Here, in the light intensity measurement method of the present disclosure, in the measurement of the light intensities in the light receiving portion 5, the exposure times of the respective light receiving elements may be set similarly to the recording of the correspondence relationships Or₂₁ to Or_{MN}. For example, when the light intensities of the respective light receiving elements received by the light receiving portion 5 are detected in a state where the incident-side optical fibers 11 and the emission-side optical fibers 12 propagate light to be measured for the intensity, measurement by the light receiving portion 5 is performed a plurality of times while the exposure times during which the emitted light 43 to the light receiving portion 5 is made incident on the respective light receiving elements are changed.

In a state where light to be measured for the intensity is propagating, it is not clear from which incident-side optical fiber 11 the incident light is made incident. Therefore, in the first light reception in the light receiving portion 5, the exposure time setting unit 51 determines from which incident-side optical fibers 11 incident light is made incident on the basis of the positions of light receiving elements that have received emitted light, determines a range of light receiving elements on the basis of the correspondence relationships expressed by Formula 1 for the respective incident-side optical fibers 11 from which the incident light is made incident, extends the exposure times of the respective light receiving elements included in the light receiving portion 5 in a case where a light intensity received by any of the light receiving elements included in the determined range is smaller than the minimum intensity Smin, and performs the second light reception in the light receiving portion 5. The measurement is repeated while the exposure times are changed until the minimum intensity Smin is exceeded in all the light receiving elements arranged in the predetermined range or the number of times of extension β reaches a predetermined number of times set in advance. The extended exposure times may be determined by KPT.

In the first light reception in the light receiving portion 5, the exposure time setting unit 51 determines from which incident-side optical fibers 11 the incident light is made incident on the basis of the positions of light receiving elements that have received emitted light, determines a range of light receiving elements on the basis of the correspondence relationships expressed by Formula 1 for the respective incident-side optical fibers 11 from which the incident light is made incident, shortens the exposure times of the respective light receiving elements included in the light receiving portion 5 in a case where a light intensity received by any of the light receiving elements included in the determined range is larger than the maximum intensity Smax, and performs the second light reception in the light receiving portion 5. The measurement is repeated while the exposure times are changed until intensities fall below the maximum intensity Smax in all the light receiving elements arranged in the predetermined range. The exposure times to be shortened may be determined by T/K^{γ} by using the number of times of shortening γ.

Here, the predetermined range may be a predetermined number of light receiving elements. Furthermore, since the number of light receiving elements to be used in the present disclosure only needs to be sufficient to solve Formula 3, the number of elements to be used can be reduced within a range in which accuracy is not affected. For example, the number of elements to be used for measurement may be determined in advance and the measurement may be repeated until elements to be used corresponding to the number exceed the minimum intensity Smin or fall below the maximum intensity Smax.

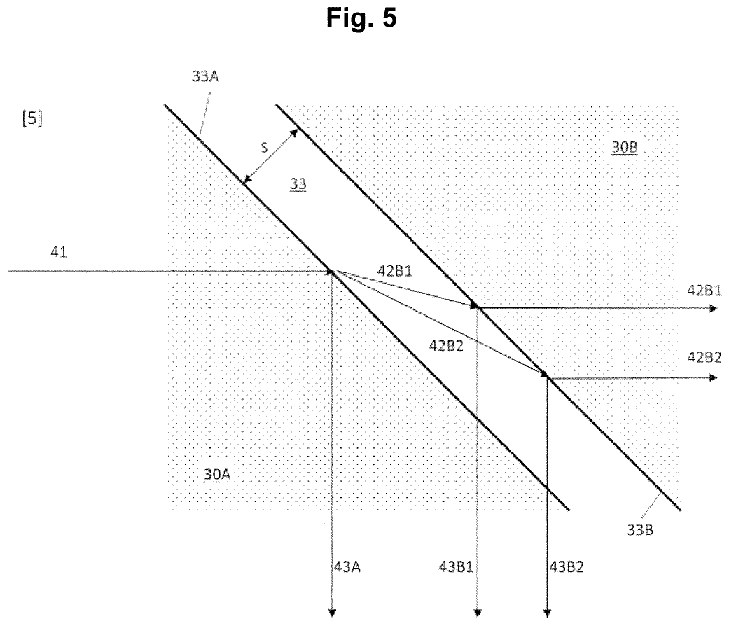

Furthermore, in the optical monitor device of the present embodiment, as illustrated in FIG. 5, the spatial optical system 30 includes a single-layer film 33 having a uniform refractive index included between an incident-side member 30A and an emission-side member 30B each including a material having a different uniform refractive index, and the single-layer film 33 is included at a specific angle (45 degrees in the drawing) with the optical axis of the incident light 41. As a result, each of a first refractive index interface 33A between the single-layer film 33 and the incident-side member 30A and a second refractive index interface 33B between the single-layer film 33 and the emission-side member 30B is included at a specific angle with the optical axis of the incident light.

In a case where the incident-side member 30A and the emission-side member 30B have the same refractive index, pieces of light 42B1 and 42B2 having different wavelengths travel in different directions in the single-layer film 33. Therefore, incident positions of the pieces of light 42B1 and 42B2 having different wavelengths on the refractive index interface 33B are different. On the other hand, light incident from the refractive index interface 33B travels in the same direction as that from the incident-side member 30A due to refraction between the single-layer film 33 and the emission-side member 30B. Therefore, even if the optical axes at the incidence end surfaces of the respective emission-side optical fibers 12 are arranged in parallel, transmitted light can be coupled to the emission-side optical fibers 12 regardless of the wavelength.

As described above, in the present disclosure, there is a difference in the incident position on the refractive index interface 33B according to the wavelength in the single-layer film 33. Therefore, in a case where the wavelengths of pieces of emitted light 43B1 and 43B2 are different, the reflection position on the refractive index interface 33B is different between the pieces of emitted light 43B1 and 43B2. Therefore, in the present disclosure, the correspondence relationships represented by Formula 1 may be acquired for each wavelength.

### Effects of Present Disclosure

According to the optical monitor device illustrated in FIG. 1, the incident-side optical fibers 11 and the emission-side optical fibers 12 are two-dimensionally arranged, and luminous fluxes in the two-dimensional arrangement are split by the spatial optical system 30. As a result, there is an effect that downsizing can be enabled as compared with a case where an optical monitor device using each optical fiber or an optical monitor device in which optical fibers are one-dimensionally arranged is used. Furthermore, since the number of constituent components is small, there is an effect that cost reduction is easy.

### Second Exemplary Embodiment

In a case of a light receiving portion 5 including shutters for respective light receiving elements like a CCD sensor, the exposure times can be changed for the respective light receiving elements. Therefore, in the present embodiment, the exposure times are extended or shortened for the respective light receiving elements.

For example, in recording of correspondence relationships Or₁₁ to Or_{MN} illustrated in FIG. 4, in a case where light that exceeds the minimum intensity Smin is detected only in light receiving elements M16, M17, M29, and M30 illustrated in FIG. 3, and the other light receiving elements do not reach the minimum intensity Smin, an exposure time setting unit 51 extends the exposure times of light receiving elements arranged in a range determined by the area around the light receiving elements M16, M17, M29, and M30. For example, the exposure time setting unit 51 extends the exposure times of light receiving elements excluding the light receiving elements M16, M17, M29, and M30 among M2 to M5, M15 to M18, M28 to M31, and M41 to M44 illustrated in FIG. 3 to KT.

After the exposure times are extended to KT, steps S12 to S14 are performed again, and recording is performed again only for recordings that fall below Smin. At this time, in the present embodiment, the light receiving portion 5 receives light from the incident-side optical fiber F1 again using the extended exposure times only for the light receiving elements excluding the light receiving elements M16, M17, M29, and M30 among M2 to M5, M15 to M18, M28 to M31, and M41 to M44 illustrated in FIG. 3.

If there is still a record that falls below Smin in step S13, the exposure times are further extended to K²T in step S11, and recording is performed again (S12 to S14). At this time, in the present embodiment, in a case where only a light receiving element M44 does not reach the minimum intensity Smin among M2 to M5, M15 to M18, M28 to M31, and M41 to M44 illustrated in FIG. 3, the exposure time setting unit 51 extends the exposure time of only the light receiving element M44.

As described above, measurement is repeated while the exposure times are changed until the intensity exceeds the minimum intensity Smin in all light receiving elements arranged in the predetermined range. The extended exposure times may be determined by KPT.

Note that, in the present embodiment, the exposure times of all the light receiving elements M2 to M5, M15 to M18, M28 to M31, and M41 to M44 that light reaches are extended, but the present disclosure is not limited thereto. Since the number of light receiving elements to be used in the present disclosure only needs to be sufficient to solve Formula 3 to be described below, the number of elements to be used can be reduced within a range in which accuracy is not affected. For example, in the example of FIG. 3, the number of elements may be determined to be four, and the exposure times of only the light receiving elements M16, M17, M29, and M30 may be extended in step S13.

Furthermore, in a case where there is a light receiving element having a light intensity larger than the maximum intensity Smax, the exposure time setting unit 51 shortens the exposure time of only the light receiving element having a light intensity larger than the maximum intensity Smax, and performs the second light reception in the light receiving portion 5. The measurement is repeated while the exposure times are changed until intensities fall below the maximum intensity Smax in all the light receiving elements arranged in the predetermined range. The exposure times to be shortened may be determined by T/K^{γ} by using the number of times of shortening γ.

In a light intensity measurement method of the present embodiment, in the measurement of the light intensity in the light receiving portion 5, the exposure times of the respective light receiving elements are set similarly to the time of recording of correspondence relationships Or₂₁ to Or_{MN}. For example, when the light intensities of the respective light receiving elements received by the light receiving portion 5 are detected in a state where the incident-side optical fibers 11 and the emission-side optical fibers 12 propagate light to be measured for the intensity, measurement by the light receiving portion 5 is performed a plurality of times while the exposure times during which the emitted light 43 to the light receiving portion 5 is made incident on the respective light receiving elements are changed for the respective light receiving elements.

In the present embodiment, the measurement is repeated while the exposure time of a light receiving element smaller than the minimum intensity Smin is changed until the minimum intensity Smin is exceeded in all the light receiving elements arranged in the predetermined range or the number of times of extension β reaches a predetermined number of times set in advance. The extended exposure times may be determined by KPT.

In the present embodiment, the measurement is repeated while the exposure time of a light receiving element larger than the maximum intensity Smax is changed until the intensity falls below the maximum intensity Smax in all the light receiving elements arranged in the predetermined range. The exposure times to be shortened may be determined by T/K^{γ} by using the number of times of shortening γ.

Here, the predetermined range may be a predetermined number of light receiving elements. Furthermore, since the number of light receiving elements to be used in the present disclosure only needs to be sufficient to solve Formula 3, the number of elements to be used can be reduced within a range in which accuracy is not affected. For example, the number of elements to be used for measurement may be determined in advance and the measurement may be repeated until elements to be used corresponding to the number exceed the minimum intensity Smin or fall below the maximum intensity Smax.

### Third Exemplary Embodiment

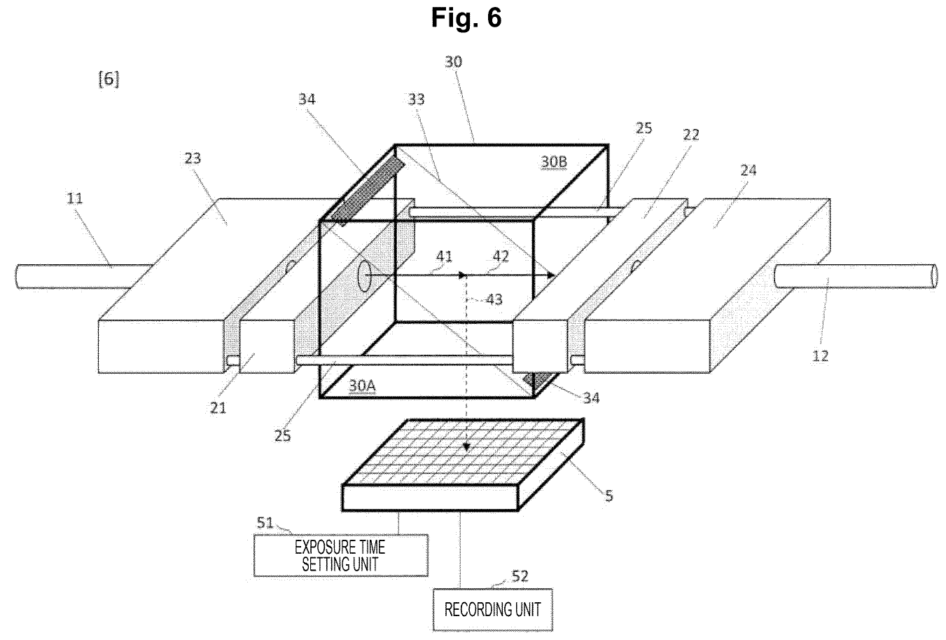

FIG. 6 illustrates a third exemplary embodiment of the present disclosure. An incident-side member 30A and an emission-side member 30B can be each formed of a transparent material such as quartz glass. In a single-layer film 33, spacers 34 each having a uniform predetermined thickness are arranged between the incident-side member 30A and the emission-side member 30B to form spaces, so that an air layer can be used. An incident-side optical lens 21 and an emission-side optical lens 22 can each be implemented by a collimator in which a GRaded INdex (GRIN) fiber is incorporated in a square ferrule used in an optical connector or the like. Similarly to the incident-side optical lens 21 and the emission-side optical lens 22, an incident-side optical fiber 11 and an emission-side optical fiber 12 are incorporated in rectangular ferrules 23 and 24, and the optical axes of the incident-side optical fiber 11, the incident-side optical lens 21, the emission-side optical fiber 12, and the emission-side optical lens 22 can be aligned using guide pins 25 and guide holes similarly to the optical connector. The light receiving portion 5 can be implemented by a commercially available optical image sensor. By a connection portion other than the single-layer film 33 being filled with a refractive index matching material, unnecessary Fresnel reflection can be reduced.

Although the above is the exemplary embodiments, the present invention is not limited thereto. For example, in the present disclosure, an example has been described in which the single-layer film 33 is an air layer, but the single-layer film 33 may be glass having a refractive index lower than those of the incident-side member 30A and the emission-side member 30B. Furthermore, the spatial optical system 30 is not limited to a cubic shape, and may have any shape such as a rectangular parallelepiped. Furthermore, the light receiving portion 5 can be arranged at any position where light split by the spatial optical system 30 can be received. For example, the light receiving portion 5 may be embedded inside the spatial optical system 30.

Furthermore, the optical monitor device of the present disclosure can be used for monitoring any light transmitted in an optical transmission system. For example, the optical monitor device of the present disclosure can be incorporated in any device used in an optical transmission system such as a transmission device, a reception device, or a relay device, and a measurement result in the light receiving portion 5 can be used for feedback or feedforward to any component inside or outside the device. Furthermore, the optical monitor device of the present disclosure can be inserted in the middle of a transmission line in an optical transmission system so as to measure the intensity and a propagation loss of an optical signal in the transmission line.

The exposure time setting unit 51 and the recording unit 52 included in the optical monitor device of the present disclosure can also be implemented by a computer and a program, and the program can be recorded in a recording medium or provided through a network. A program of the present disclosure is a program for causing a computer to implement the exposure time setting unit 51 or the recording unit 52 included in the optical monitor device of the present disclosure, and is a program for causing a computer to execute each step included in the method executed by the optical monitor device according to the present disclosure.

### REFERENCE SIGNS LIST

5 Light receiving portion
11 Incident-side optical fiber
12 Emission-side optical fiber
21 Incident-side optical lens
22 Emission-side optical lens
23, 24 Ferrule
25 Guide pin
30 Spatial optical system
30A Incident-side member
30B Emission-side member
33 Single-layer film
34 Spacer
41 Incident light
42 Most emitted light
43 Part of emitted light
51 Exposure time setting unit
52 Recording unit

1. An optical monitor device that detects an intensity of light propagating through a plurality of optical fibers, the optical monitor device comprising:
an optical component that splits a part of incident light from the plurality of optical fibers into a first direction and a rest into a second direction at a constant splitting ratio, and emits light; and
a light receiving portion that receives emitted light in a second direction from the optical component,
wherein the light receiving portion includes a light receiving surface having a size that enables light reception of all emitted light from the optical component in the second direction,
light receiving elements larger in number than the optical fibers are two-dimensionally arranged on the light receiving surface, and
exposure times of the light receiving elements are variable.

2. The optical monitor device according to claim 1 comprising
an exposure time setting unit that changes the exposure times such that a ratio Smax/Smin of a measurable maximum intensity Smax and a minimum intensity Smin of the light receiving elements is made smaller than a ratio Pmax/Pmin of a maximum intensity Pmax and a minimum intensity Pmin of light to be measured.

3. The optical monitor device according to claim 1,
wherein an exposure time is variable for each of the light receiving elements in the light receiving portion.

4. The optical monitor device according to claim 1,
wherein the optical component includes:
a single-layer film having a uniform thickness;
an incident-side member included on an incident side of the single-layer film and having a refractive index different from a refractive index of the single-layer film; and
an emission-side member included on an emission side of the single-layer film and having a same refractive index as a refractive index of the incident-side member,
each of a first refractive index interface between the single-layer film and the incident-side member and a second refractive index interface between the single-layer film and the emission-side member is included at a specific angle with respect to an optical axis of incident light,
the first direction is a direction in which transmission occurs through the first refractive index interface and the second refractive index interface, and
the second direction is a direction in which reflection occurs on the first refractive index interface and the second refractive index interface.

5. A light intensity measurement method for collectively measuring intensities of light propagating through a plurality of optical fibers using the optical monitor device according to claim 1, the light intensity measurement method comprising:
acquiring in advance correspondence relationships between the plurality of optical fibers and each light receiving element by measuring a received light intensity at each light receiving element when light is emitted by each optical fiber from the plurality of optical fibers; and
measuring a light intensity of each light receiving element received by the light receiving portion in a state where the plurality of optical fibers is propagating light to be measured for an intensity,
wherein the measurement is performed a plurality of times while an exposure time during which emitted light in the second direction is incident on each light receiving element is changed.

6. The light intensity measurement method according to claim 5,
wherein in the measurement,
an exposure time of a light receiving element is extended in a case where a light intensity received by any of the light receiving elements arranged in a range determined by the correspondence relationships is smaller than a minimum intensity Smin of the light receiving elements, and
an exposure time of a light receiving element is shortened in a case where a light intensity received by any one of the light receiving elements arranged in a range determined by the correspondence relationships is larger than a maximum intensity Smax of the light receiving elements.

7. The light intensity measurement method according to claim 6,
wherein in the measurement,
an exposure time of a light receiving element smaller than a minimum intensity Smin is extended until a minimum intensity Smin is exceeded in all the light receiving elements arranged in a range determined in the correspondence relationships or a number of times of extension β reaches a predetermined number set in advance, and
an exposure time of a light receiving element larger than a maximum intensity Smax is shortened until an intensity falls below a maximum intensity Smax in all the light receiving elements arranged in a range determined by the correspondence relationships.

8. The light intensity measurement method according to claim 7,
wherein the exposure time is
determined by KRT by using a number of times of extension β, and
determined by T/K^{γ} by using a number of times of shortening γ.
